(19) United States
(12) Patent Application Publication
(10) Pub. No.: US 2012/0209446 A1
(43) Pub. Date: Aug. 16, 2012

(54) APPLIANCE WITH A CONTROLLER CONFIGURED TO CONNECT TO A NETWORK AND ASSOCIATED SYSTEM AND METHOD

(75) Inventors: Dennis A. Poyner, Kinston, NC (US); Mark D. Montgomery, Greenville, NC (US); Kyle T. Perkinson, Greenville, NC (US)

(73) Assignee: Electrolux Home Products, Inc.

(21) Appl. No.: 13/027,704

(22) Filed: Feb. 15, 2011

(51) Int. Cl. G06F 1/26; G06F 1/32

(52) U.S. Cl. 700/297; 700/286

(57) ABSTRACT

According to embodiments of the present invention, an appliance may include operating assemblies configured to employ utilities to perform one or more functions. A controller may be configured to control the operating assemblies. The controller may include a network interface and a user interface. The network interface may communicate utility data relating to the utilities with a network. The user interface may be configured to receive user inputs and output status indicators relating to the utility data received from the network. The utility data may include a utility demand level and a utility unit price. Further, a system is also provided that may include the appliance, an additional appliance, and an intermediate controller. The intermediate controller may be configured to communicate with the network and direct modification of the functions performed by the appliance and the additional appliance based on the utility data. Related methods are also provided.

### BACKGROUND OF THE INVENTION

I. Field of the Invention

Embodiments of the present invention are generally related to appliances configured to connect to a network and, more particularly, to appliances with a controller configured to connect to a network and output utility data.

II. Description of Related Art

One issue of interest in the field of appliances is to adjust power usage and reduce costs associated with operation of the appliances. In this regard, efforts have been made to develop a Smart Grid. A Smart Grid allows utility providers to communicate information to appliances and/or receive information therefrom. Accordingly, operation of appliances connected to the Smart Grid may be adjusted. For example, the Smart Grid may direct the appliances connected to the grid to delay operation until after peak-demand periods. Thereby, the utility provider may accommodate the same energy usage with reduced power production capacity by spreading the energy usage across the course of a day.

For example, without the Smart Grid a utility may need to bring additional electrical generating equipment on-line for short periods of time to meet peak demands. Such equipment may have a relatively long start-up period during which efficiency levels are low. This additional equipment may also be older and have a relatively less efficient generating capacity. Further, even at peak demand levels the additional equipment may not reach a load level that coincides with its maximum efficiency. With the Smart Grid the load may be leveled such that it is more consistent and it may be possible to eliminate use of additional power generation equipment. The more predictable load that may result from implementation of Smart Grid may also allow the utility provider to size equipment so that the load range more closely coincides with a higher efficiency range of operation for the installed generating equipment. The Smart Grid may additionally encourage consumer behavior that shifts power usage to off peak time periods by adjusting pricing based on peak usage time periods. Further, the Smart Grid may provide users with feedback regarding power usage and/or costs that may encourage users to alter their usage of appliances and reduce power consumption. Since Smart Grid technologies are not yet fully implemented, further advantages may be achieved.

### BRIEF SUMMARY OF THE INVENTION

In this regard, advantages may be provided by an appliance presented herein that may comprises one or more operating assemblies configured to employ one or more utilities to perform one or more functions, and a controller configured to control the one or more operating assemblies. The controller comprises a network interface configured to connect to a network and communicate a plurality of utility data with the network. The utility data may relate to the utilities consumed by the appliance. Further, the controller includes a user interface configured to receive one or more user inputs from a user and output at least one status indicator relating to the utility data received from the network.

In one embodiment the utility data comprises a utility demand level, and the status indicator may correspond to the utility demand level. The controller may be configured to prompt the user for selection of one or more conservation modes when the utility demand level exceeds a threshold utility demand level. In another embodiment the utility data may comprise a utility unit price and the status indicator may correspond to the utility unit price. The controller may be configured to prompt the user for selection of one or more conservation modes when the utility unit price exceeds a threshold utility unit price.

The controller may be configured to control one or more of the functions performed by the one or more operating assemblies based at least in part on the utility data. The status indicator may indicate a level of control of the one or more appliance functions based on the utility data and/or indicate changes made by the controller to the one or more appliance functions based on the utility data. Further, the user interface may be configured to modify the status indicator when the utility data exceeds a threshold.

In a further embodiment a method for controlling an appliance is provided which may also present advantages. The method may include controlling one or more functional assemblies configured to employ one or more utilities to perform one or more functions with a controller comprising a network interface and a user interface. Also, the method may comprise connecting to a network with the network interface, communicating a plurality of utility data with the network, receiving one or more user inputs from a user with a user interface, and outputting at least one status indicator relating to the utility data received from the network with the user interface. The utility data relates to the utilities consumed by the appliance in some embodiments.

Communicating the utility data with the network may comprise receiving a utility demand level, and outputting the status indicator may comprise outputting the utility demand level. The method may also include prompting the user for selection of one or more conservation modes when the utility demand level exceeds a threshold utility demand level. Communicating the utility data with the network may additionally or alternatively comprise receiving a utility unit price, and outputting the status indicator may comprise outputting the utility unit price. The method may also include prompting the user for selection of one or more conservation modes when the utility unit price exceeds a threshold utility unit price.

In one embodiment the method may further comprise controlling one or more of the functions performed by the one or more operating assemblies based at least in part on the utility data. Outputting the status indicator may comprise outputting a level of control of the one or more functions based on the utility data and/or indicating changes made by the controller to the one or more functions based on the utility data. In some embodiments the method may also include selectively directing the controller to modify one or more of the functions with an intermediate controller. The method may further include modifying the status indicator when the utility data exceeds a threshold.

In an additional embodiment a system is provided which may provide advantages. The system may comprise an appliance, an additional appliance and an intermediate controller. In some embodiments the appliance may comprise one or more operating assemblies configured to employ one or more utilities to perform one or more functions and an appliance controller configured to control the one or more operating assemblies. The appliance controller may comprise a network interface configured to connect to a network and receive a plurality of utility data from the network and a user interface. The user interface may be configured to receive one or more user inputs from a user and output at least one status indicator relating to the utility data received from the network.

The additional appliance, which may comprise an additional controller, may be configured to employ one or more of the utilities to perform one or more additional functions. Further, the intermediate controller may be configured to communicate with the network, the appliance, and the additional appliance. Also, the intermediate controller may be configured to selectively direct the appliance controller and the additional controller to modify one or more of the functions and the additional functions based at least in part on the utility data.

These and other aspects and features of the invention may be better understood with reference to the following description and accompanying drawings.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic view of a Smart Grid connected to a dishwasher according to one embodiment of the invention;

FIG. 2 illustrates a sectional view through a dishwasher which may be included in the Smart Grid according to one embodiment of the present invention;

FIG. 3 illustrates an alternate embodiment of a Smart Grid including an intermediate controller according to one embodiment of the present invention; and

FIG. 4 illustrates a method for controlling an appliance such as a dishwasher according to one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present disclosure may be employed in conjunction with various appliances and various utilities employed in the operation of the appliances. For example, some appliances may employ water, gas, electricity, data transmission, wastewater disposal and/or other utilities in the performance of their respective functions. However, for purposes of brevity, a utility provider will generally be described herein as comprising an electrical utility provider configured to provide electricity to appliances. Further, the appliance will generally be described with reference to a dishwasher, also for brevity purposes. However, as may be understood by one having skill in the art, various other embodiments of utilities, utility providers, and appliances may employ the teachings described herein.

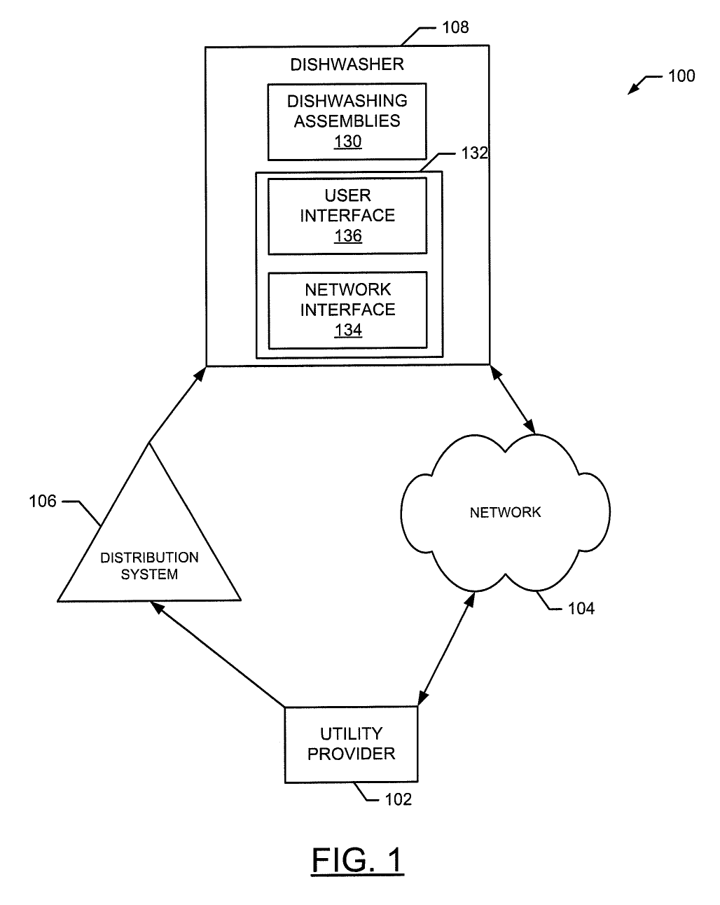

In this regard, one example embodiment of a Smart Grid 100 is illustrated in FIG. 1. As illustrated, the Smart Grid 100 may comprise a utility provider 102, a network 104, a distribution system 106, and appliances such as the illustrated dishwasher 108. As noted above, various other embodiments of appliances comprising associated operating assemblies configured to perform respective functions may additionally or alternatively be included in the Smart Grid 100 in some embodiments. As further noted above, the utility provider 102 may comprise an electrical utility provider in one embodiment. Thus, the distribution system 106 may comprise an electrical distribution grid configured to distribute electricity.

The network 104 may comprise a data network configured to communicate data. For example, the network 104 may include a collection of various different nodes, devices or functions that may be in communication with each other via corresponding wired and/or wireless interfaces. As such, the illustration of FIG. 1 should be understood to be an example of a broad view of certain elements of the Smart Grid 100 and not an all inclusive or detailed view of the Smart Grid or the network 104. Although not necessary, in some embodiments, the network 104 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 104 may be a cellular network, a mobile network and/or a data network, such as a local area network (LAN), a metropolitan area network (MAN), and/or a wide area network (WAN), for example, the Internet.

In turn, other devices such as processing elements (for example, personal computers, server computers or the like) may be included in or coupled to the network 104. By directly or indirectly connecting the utility provider 102, the dishwasher 108 and/or other devices to the network 104, the devices may be enabled to communicate with each other, for example, according to numerous communication protocols including Hypertext Transfer Protocol (HTTP) and/or the like, to thereby carry out various communication or other functions. As such, the utility provider 102, the dishwasher 108, and the other devices may be enabled to communicate with the network 104 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 104 may comprise a home network or other network providing local connectivity.

Accordingly, the data network 104 may transfer data between the utility provider 102 and the dishwasher 108. For example, the network 104 may send and receive utility data. Utility data, as used herein, may refer to data that relates to volume or power demand for the utility (e.g. kilowatts of electricity) throughout the utility's customer base, or a utility unit price. For example, the price for electricity may be described in terms of the price per kilowatt-hour in some embodiments. Utility data may also relate to actual or expected energy consumption by one or more appliances, such as the dishwasher 108. Thus, the term utility data may be used to describe one or more of various types of data relating to the production of, consumption of, and/or demand for, one or more utilities, as well as any other data relating to the utilities. Accordingly, the network 104 may transfer various types of utility data between the utility provider 102 and appliances such as the dishwasher 108. The utility data may be employed for a variety of purposes, as will be discussed below.

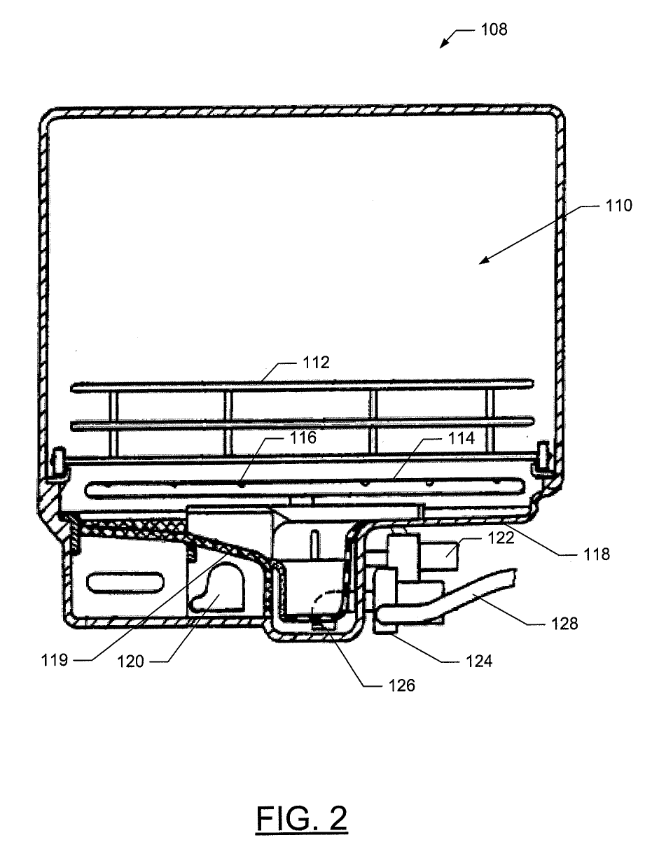

With regard to the appliances that are connected to the Smart Grid 100, the appliances may generally be similar to existing appliances in some embodiments. For example, the dishwasher 108 may comprise one or more dishwashing assemblies configured to employ one or more utilities to perform one or more dishwashing functions. In this regard, FIG. 2 illustrates a sectional view through an example embodiment of the dishwasher 108. As illustrated, the dishwasher 108 may comprise a washing chamber 110 in which dishware may be inserted in a dish rack 112. In the washing chamber 110 there may be one or more rotating spray arms 114 that are configured to direct the circulating dishwashing fluid through spray nozzles 116 towards the dishware that is placed in the dish rack 112. The circulating dishwashing fluid may drain down to a bottom wall 118 of the washing chamber 110 and thereby the dishwashing fluid may be directed through a filter 119 towards an inlet 120 for a circulation pump 122 for redistribution of the dishwashing fluid to the rotating spray arm 114.

When a washing cycle is complete, the dishwasher 108 may dispose of the soiled water. In this regard, the dishwasher 108 may further comprise a drain pump 124 that is configured to pull the soiled water from the washing chamber 110 through an inlet 126 and discharge the soiled water through a fluid conduit such as the illustrated drain hose 128. The drain hose 128 may lead to plumbing within a home or other structure in which the dishwasher 108 is installed and then to a wastewater utility. Further, various heating elements, fans, etc. may be employed to heat water, dry the dishware, etc.

Accordingly, various ones of the above-described dishwashing assemblies (schematically indicated by reference numeral 130 in FIG. 1) may be configured to employ utilities (e.g. water and electricity) to perform one or more dishwashing functions. As illustrated in FIG. 1, the dishwasher 108 may further include a controller 132 configured to control the dishwashing assemblies 130. The controller 132 may comprise a network interface 134 and a user interface 136 in some embodiments.

The network interface 134 may be configured to connect to the network 104 and communicate a plurality of utility data with the network. As described above, the utility data may relate to utilities (e.g. water and/or electricity). By way of example, the utility data may relate to a utility demand level, a utility unit price, etc. In some embodiments the utility data may relate to utilities consumed by the dishwasher 108. For example, the utility data may relate to utility consumption data specific to the dishwasher or one or more dishwasher assemblies defined by the dishwasher. Accordingly, communicating utility data with the network 104 may include sending and/or receiving utility data.

As noted above, the controller 132 may also include the user interface 136. The user interface 136 may be configured to receive one or more inputs from a user. For example, the user interface 136 may include one or more switches, dials, buttons, touch-screens, and/or other input devices. In some embodiments the controller 132 may be configured to receive user inputs remotely. For example, a wired or wireless (e.g. infrared, Bluetooth, WiFi, etc.) connection may be established with a personal computer, smartphone, or other device. Thereby, the user interface may be embodied at least partially on the remote device (e.g. smartphone or computer), and thus the user may provide inputs from a remote location. Regardless of whether the inputs are provided locally or remotely, the user may select one or more functions or modes, or otherwise control or influence the operation of the dishwasher 108.

The user interface 136 may also be configured to output at least one status indicator relating to the utility data received from or sent to the network 104. The status indicator may be displayed in a variety of forms. For example, the status indicator may comprise one or more displays, lights, noises, vibrations etc. Thereby, the status indicator may display information relating to the utility data in a variety of forms. For example, numerical information may be displayed, graphical information may be displayed, binary or scaled information may be displayed, etc. The status indicator may be outputted locally and/or remotely. For example, the status indicator may be outputted at the dishwasher 108, and/or the status indicator may be outputted on a remote device such as a smartphone or personal computer.

Further, as noted above, the status indicator may in some embodiments relate to the utility data received from the network 104. Thus, for example, the utility data may comprise a utility demand level in some embodiments, and the status indicator may correspond to the utility demand level. By way of further example, a utility demand level may be displayed numerically, shown as a graph over a period of time, and/or otherwise outputted in raw, scaled, or other forms. Thereby the status indicator may present the user with utility data relating to the utility demand level.

Alternatively, or additionally, the utility data may comprise a utility unit price in some embodiments. Thus, for example, the utility unit price may be displayed numerically, shown as a graph over a period of time, and/or otherwise outputted in raw, scaled, or other forms. Thereby the status indicator may present the user with utility data relating to the utility unit price.

In some embodiments the user interface 136 may be configured to modify the status indicator when the utility data exceeds a threshold. For example, when the status indicator relates to the utility demand level or the utility unit price, the status indicator may change color, flash, or otherwise accentuate the utility demand level or utility unit price when one exceeds one or more threshold values. In some embodiments the threshold may be user selectable. Thereby, the user may determine the threshold values at which the user will be alerted.

For example, the user may select an upper threshold for the utility unit price. Thereby, the user may be alerted when the price of the utility becomes relatively expensive. Alternatively or additionally, the user may select a lower threshold for the utility unit price. Thereby, the user may be alerted when the price of the utility is relatively low. Accordingly, in some embodiments the user may set one or more thresholds at which the user interface 136 modifies the status indicator so that the user may be aware of changes to the utility unit price, utility demand level, or other utility data.

In other embodiments the controller 132 may set one or more thresholds for the utility data at which the user interface 136 modifies the status indicator. For example, the controller 132 may set upper and/or lower thresholds for utility demand level in order to alert the user of times when it may be desirable to wait or proceed with washing dishes (or perform other functions in other embodiments of appliances). In some embodiments the controller 132 may store and analyze data for the utility demand level, utility unit price, and/or other utility data that is outputted as one or more status indicators. Thereby, the controller 132 may calculate an average for each type of utility data and/or perform other data analysis and select one or more thresholds based thereon. For example, the user may be notified when the utility unit price or utility demand level is below or above a calculated average. In other embodiments the user may be notified when the utility unit price or utility demand level is expected to increase or decrease based on historical trends or other information. In a further embodiment the utility provider 102 or other remotely located entity may set the thresholds and transmit the thresholds to the dishwasher 108.

In some embodiments the controller 132 may be configured to prompt the user for selection of one or more conservation modes when the utility data exceeds a threshold, such as a threshold utility demand level and/or a threshold utility unit price. The conservation modes may adjust one or more operating parameters of the dishwashing assemblies 130. The controller 132 may in some embodiments monitor the energy consumption by each of the dishwashing assemblies 130 and make adjustments to the dishwashing assemblies based thereon. For example, the conservation modes may adjust water usage, cycle duration, cleaning of the filter 119, detergent usage, water temperatures, drying temperatures, vent fans and speeds of the pumps 122, 124. Thereby, the user may select a conservation mode so as to reduce the consumption of one or more utilities during operation of the dishwasher 108. Alternatively a conservation mode may delay implementation of one or more of the dishwashing functions. For example, it may be desirable to delay washing dishes until after a period of time with a relatively high utility demand level or utility unit price has passed. Thus, the user may be alerted of relatively high utility demand levels, utility unit prices, and/or other relevant utility data and provided with the option to manually select one or more conservation modes.

However, in some embodiments the controller 132 may additionally or alternatively be configured to control one or more of the dishwashing functions performed by the one or more dishwashing assemblies 130 based at least in part on the utility data. For example, the controller 132 may provide the user with the option to allow the controller to make changes to the dishwashing assemblies 130. Thus, the controller 132 may automatically implement a resource-saving mode, such as one of the above-described conservation modes, based on the utility data. For example, the controller 132 may automatically implement a conservation mode when the utility demand level exceeds a threshold utility demand level and/or when the utility unit price exceeds a threshold utility unit price. Thereby, demand for the utility provided by the utility provider 102 may be reduced and/or the dishwasher 108 may consume less of the utility and hence the utility bill for the user of the dishwasher may be reduced and/or load on the utility provider during a period of relatively high demand may be reduced.

Thus, in some embodiments the controller 132 may interpret utility data such as the utility unit price and/or utility demand level in order to determine when to make changes to the dishwashing assemblies 130 of the dishwasher 108. However, in some embodiments the utility data may include instructions for reducing power consumption. For example, during periods of high demand the utility provider 102 may output utility data comprising instructions that request or require reduced usage of the utility. Thereby, in some embodiments, the decision as to whether to reduce utility consumption, and/or how to reduce energy consumption, may occur at least partially externally from the controller 132. However, in some embodiments the user may still be provided with the option to allow or disallow changes to the dishwashing functions.

In some embodiments the status indicator may indicate a level of control of the one or more dishwasher functions based on the utility data. In this regard, the status indicator may indicate whether or not the controller 132 is allowed to make changes to the dishwashing functions performed by the dishwashing assemblies 130. Further, the status indicator may differentiate between various levels of control. For example, the controller 132 may not be authorized to make changes, the controller may be authorized to make some changes, or the controller may be authorized to make all changes determined to be appropriate by the controller and/or requested in instructions from the utility provider 102. Accordingly, the status indicator may thus indicate the level of control the controller 132 has over the dishwasher functions.

Further, in some embodiments the status indicator may indicate changes made by the controller 132 to the one or more dishwasher functions based on the utility data. Thus, rather than indicating a level of control available to the controller 132, a status indicator may additionally or alternatively indicate changes implemented by the controller, for example, under one of the above-described control schemes. For example, in one embodiment the status indicator may indicate that a change has been made without specifically indicating to the user what the change is. Alternatively, the status indicator may indicate (under one of various levels of specificity) the particular change that was implemented. For example, if the drying cycle has been shortened fifteen minutes, the status indicator may indicate that a cycle has been changed, indicate that the drying cycle has been changed, indicate that the drying cycle has been shortened, or indicate that the drying cycle has been shortened 15 minutes in various embodiments. Thus, changes implemented by the controller 132 based on the utility data may be indicated by the status indicator in a variety of ways.

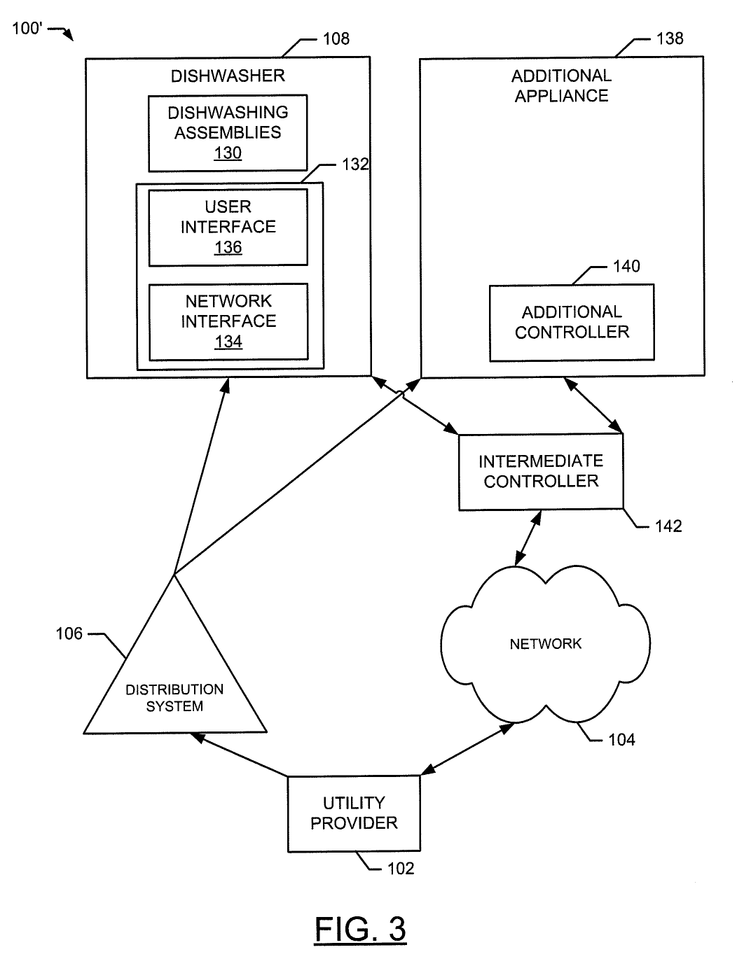

The controller 132 is generally described above as making changes to the dishwasher functions, or implementing the changes as directed by the utility provider 102. However, in other embodiments an intermediate controller may be employed for one or both of these purposes. For example, FIG. 3 illustrates an embodiment of a Smart Grid 100′ which may include embodiments of the dishwasher 108 (or other appliance), the distribution system 106, the network 104, and the utility provider 102. The Smart Grid 100′ may also include one or more additional appliance(s) 138. The additional appliance 138 may be configured to employ one or more of the utilities to perform one or more additional functions. Further, each additional appliance 138 may include a controller 140 (i.e. the “additional controller”).

Additionally, the Smart Grid 100′ may include an intermediate controller 142. The intermediate controller 142 may be positioned locally or remotely relative to the dishwasher 108 and the additional appliance 138 in various embodiments. For example, in some embodiments the intermediate controller 142 may be embodied in one of the appliances (e.g. the dishwasher 108 and/or the additional appliance 138). In other embodiments the intermediate controller 142 may be a separate entity that is positioned remotely. For example, each home, condominium, or communal living facility (e.g. a college dorm or apartment complex) may include an intermediate controller 142. Alternatively, the intermediate controller 142 may be embodied on the network 104 and employ cloud computing. Various other locations and arrangements may be employed for the intermediate controller 142 in other embodiments.

The intermediate controller 142 may be configured to communicate with the network 104, the dishwasher 108, and the additional appliance 138. Further, the intermediate controller 142 may be configured to selectively direct the controller 132 of the dishwasher 108 (i.e. the “dishwasher controller”) and the additional controller 140 to modify one or more of the dishwashing functions and the additional functions based at least in part on the utility data. Thus, the intermediate controller 142 may serve as a gateway that directs modification of the functions performed by the dishwasher 108 and the other appliance 138.

In particular, the intermediate controller 142 may prioritize the dishwasher 108 and the other appliance(s) 138 in terms of their importance. For example, if the additional appliance 138 comprises a medical device that the user needs to use for medical reasons, then the intermediate controller 142 may prioritize the additional appliance as being more important than the dishwasher 108. Depending on the importance of the additional appliance 138, the intermediate controller may completely avoid modifying the additional functions performed by the additional appliance. In some embodiments the importance level assigned to each appliance may be user selectable. For example, the intermediate controller 142 may allow the user to enter an order of importance for each appliance and/or select a particular level of control allowable for each appliance.

Alternatively, the intermediate controller 142 may select the importance levels based on product information relating to the appliances 108, 138. For example, the appliances 108, 138 may include identifiers and other information stored therein that is readable by the intermediate controller 138. Thus, in some embodiments the intermediate controller 142 may determine the importance levels based on information from the appliances 108, 138 directly indicating their importance levels or from a determination based on the characteristics of the appliances. For example, delaying operation of the dishwasher 108 may be acceptable, whereas delaying operation of the additional appliance 138 when it is a medical device may not be acceptable. Accordingly, those appliances for which modification of their functions is unacceptable or should be limited in some manner may be treated accordingly. Thereby, the intermediate controller 142 may modify the functions of the dishwasher 108 and/or the additional appliance(s) 138 based on the utility data (e.g. utility unit price and/or utility demand level) and the importance levels of the appliances. Accordingly, utility consumption by the appliances 108, 138 may be reduced or delayed until lower demand or lower price time periods.

In a further example embodiment, the additional appliance(s) 138 may comprise a hot water heater. The intermediate controller 142 may be configured to direct the hot water heater to reduce its set point temperature to thereby reduce consumption of a utility used to heat the water. In order to compensate for the cooler hot water temperature, the intermediate controller 142 may alert the dishwasher 108 of the reduced temperature so that the dishwasher may adjust its wash cycle parameters accordingly. For example, cycle duration may be lengthened to accommodate the cooler hot water temperature. Accordingly, the intermediate controller 142 may coordinate adjustments in utility usage so that inter-related appliances may still function properly.

As briefly noted above, in some embodiments the utility data may in some embodiments relate to actual or expected power consumption by one or more appliances. In this regard, the controllers (e.g., the controller 132 and/or the intermediate controller 142) may send utility data through the network 104 to the utility provider 102 relating to the actual or expected consumption of utilities by the appliances associated therewith (e.g., the dishwasher 108 and/or the additional appliances 138). In this regard, the calculation of expected utility usage may occur at the utility provider 102 and/or at the controllers (e.g., the controller 132 and/or the intermediate controller 142). Regardless, the utility provider 102 may use this information to adjust the power output it produces and/or delay or reduce power consumption by the appliances, as discussed above. Thereby, for example, the utility provider may predict possible shortfalls in power and bring online extra power production capacity or take steps to reduce or delay power consumption.

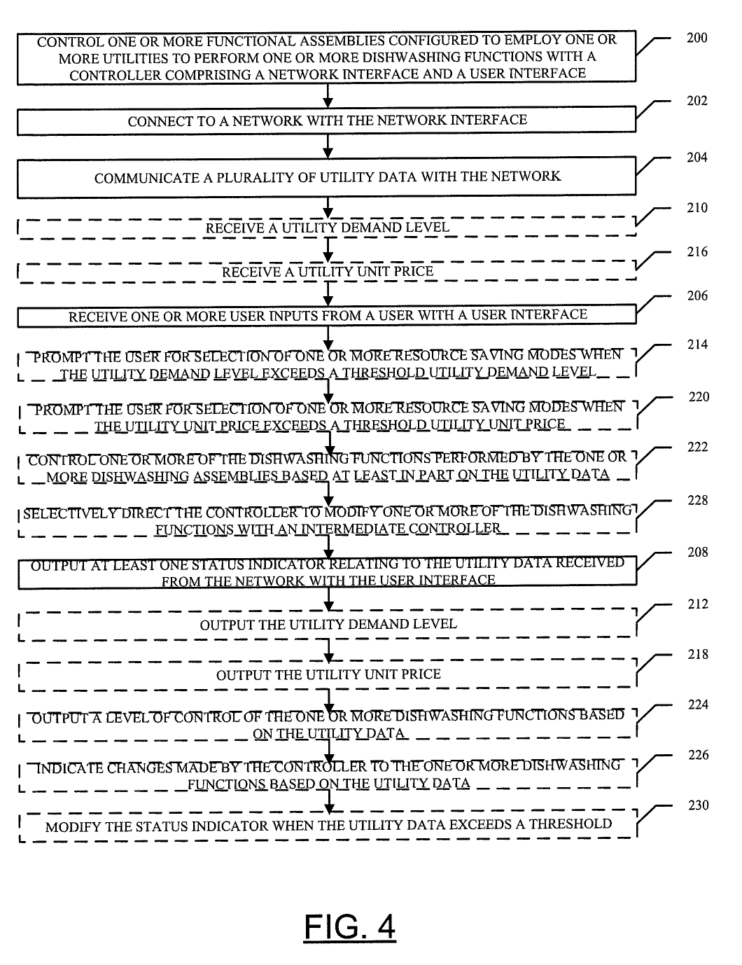

In a further embodiment a method for controlling a dishwasher is provided. As illustrated in FIG. 4, the method may include steps including controlling one or more functional assemblies configured to employ one or more utilities to perform one or more dishwashing functions with a controller comprising a network interface and a user interface at operation 200. Further, the method may include connecting to a network with the network interface at operation 202. Additionally, the method may comprise communicating a plurality of utility data with the network, wherein the utility data relates to the utilities consumed by the dishwasher at operation 204. The method may also include receiving one or more user inputs from a user with a user interface at operation 206. The method may further comprise outputting at least one status indicator relating to the utility data received from the network with the user interface at operation 208.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-208) either alone or in combination with any others described herein. As such, each of the other operations as will be described herein may be combinable with the above-described operations (200-208) either alone or with one, more than one, or all of the additional operations in any combination.

For example, communicating the utility data with the network at operation 204 may comprise receiving a utility demand level at operation 210. Accordingly, outputting the status indicator at operation 208 may comprise outputting the utility demand level at operation 212. The method may further comprise prompting the user for selection of one or more conservation modes when the utility demand level exceeds a threshold utility demand level at operation 214.

In another embodiment communicating the utility data with the network at operation 204 may comprise receiving a utility unit price at operation 216. Accordingly, outputting the status indicator at operation 208 may comprise outputting the utility unit price at operation 218. The method may further comprise prompting the user for selection of one or more conservation modes when the utility unit price exceeds a threshold utility unit price at operation 220.

Additionally, the method may include controlling one or more of the dishwashing functions performed by the one or more dishwashing assemblies based at least in part on the utility data at operation 222. In this embodiment outputting the status indicator at operation 208 may comprise outputting a level of control of the one or more dishwashing functions based on the utility data at operation 224. In another embodiment outputting the status indicator at operation 208 may comprise indicating changes made by the controller to the one or more dishwashing functions based on the utility data at operation 226. Also, the method may include selectively directing the controller to modify one or more of the dishwashing functions with an intermediate controller at operation 228. The method may additionally include modifying the status indicator when the utility data exceeds a threshold at operation 230.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An appliance, comprising:
one or more operating assemblies configured to employ one or more utilities to perform one or more functions; and
a controller configured to control the one or more operating assemblies, the controller comprising:
a network interface configured to connect to a network and communicate a plurality of utility data with the network; and
a user interface configured to:
receive one or more user inputs from a user; and
output at least one status indicator relating to the utility data received from the network.

2. The appliance of claim 1, wherein the utility data comprises a utility demand level, and
wherein the status indicator corresponds to the utility demand level.

3. The appliance of claim 2, wherein the controller is configured to prompt the user for selection of one or more conservation modes when the utility demand level exceeds a threshold utility demand level.

4. The appliance of claim 1, wherein the utility data comprises a utility unit price, and
wherein the status indicator corresponds to the utility unit price.

5. The appliance of claim 4, wherein the controller is configured to prompt the user for selection of one or more conservation modes when the utility unit price exceeds a threshold utility unit price.

6. The appliance of claim 1, wherein the controller is configured to control one or more of the functions performed by the one or more operating assemblies based at least in part on the utility data.

7. The appliance of claim 6, wherein the status indicator indicates a level of control of the one or more appliance functions based on the utility data.

8. The appliance of claim 6, wherein the status indicator indicates changes made by the controller to the one or more appliance functions based on the utility data.

9. The appliance of claim 1, wherein the user interface is configured to modify the status indicator when the utility data exceeds a threshold.

10. The appliance of claim 1, wherein the utility data relates to the utilities consumed by the appliance

11. A method for controlling an appliance, comprising the steps of:
controlling one or more functional assemblies configured to employ one or more utilities to perform one or more functions with a controller comprising a network interface and a user interface;
connecting to a network with the network interface;
communicating a plurality of utility data with the network;
receiving one or more user inputs from a user with a user interface; and
outputting at least one status indicator relating to the utility data received from the network with the user interface.

12. The method of claim 11, wherein communicating the utility data with the network comprises receiving a utility demand level, and
wherein outputting the status indicator comprises outputting the utility demand level.

13. The method of claim 12, further comprising prompting the user for selection of one or more conservation modes when the utility demand level exceeds a threshold utility demand level.

14. The method of claim 11, wherein communicating the utility data with the network comprises receiving a utility unit price, and
wherein outputting the status indicator comprises outputting the utility unit price.

15. The method of claim 14, further comprising prompting the user for selection of one or more conservation modes when the utility unit price exceeds a threshold utility unit price.

16. The method of claim 11, further comprising controlling one or more of the functions performed by the one or more operating assemblies based at least in part on the utility data.

17. The method of claim 16, wherein outputting the status indicator comprises outputting a level of control of the one or more functions based on the utility data.

18. The method of claim 16, wherein outputting the status indicator comprises indicating changes made by the controller to the one or more functions based on the utility data.

19. The method of claim 16, further comprising selectively directing the controller to modify one or more of the functions with an intermediate controller.

20. The method of claim 11, further comprising modifying the status indicator when the utility data exceeds a threshold.

21. The method of claim 11, wherein the utility data relates to the utilities consumed by the appliance

22. A system, comprising:
an appliance comprising
one or more operating assemblies configured to employ one or more utilities to perform one or more functions; and
an appliance controller configured to control the one or more operating assemblies, the appliance controller comprising:
a network interface configured to connect to a network and receive a plurality of utility data from the network; and
a user interface configured to:
receive one or more user inputs from a user; and
output at least one status indicator relating to the utility data received from the network;
an additional appliance configured to employ one or more of the utilities to perform one or more additional functions, wherein the additional appliance comprises an additional controller; and
an intermediate controller configured to:
communicate with the network, the appliance, and the additional appliance; and
selectively direct the appliance controller and the additional controller to modify one or more of the functions and the additional functions based at least in part on the utility data.
